(19) United States
(12) Patent Application Publication
(10) Pub. No.: US 2008/0222513 A1
(43) Pub. Date: Sep. 11, 2008

(54) Method and System for Rules-Based Tag Management in a Document Review System

(75) Inventor: Willem R. Van Den Berge, El Paso, TX (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: ALTEP, INC., El Paso, TX (US)

(21) Appl. No.: 12/038,795

(22) Filed: Feb. 27, 2008

Related U.S. Application Data
(60) Provisional application No. 60/893,616, filed on Mar. 7, 2007.
(60) Provisional application No. 60/893,613, filed on Mar. 7, 2007.

(51) Int. Cl. G06F 17/00

(52) U.S. Cl. 715/234

(57) ABSTRACT

A system and method for reviewing documents are described. In one embodiment, the system includes an process configured to retrieve a document; an process configured to display the document; an process configured to create a plurality of tags, each of the plurality of tags being associated with a document characteristic; an process configured to define at least one rule, each rule being a restriction on the application of the plurality of tags to the plurality of documents; an process configured to associate at least one of the plurality of tags to the document; and an process configured to validate whether the plurality of tags assigned to the plurality of documents are consistent with each rule. In other embodiments, the process includes a machine-readable medium that provides instructions for a processor, which when executed by the processor cause the processor to perform a method of the present invention.

### CROSS-REFERENCE TO RELATED APPLICATIONS

This application claims benefit and priority under 35 U.S.C. § 119(e) of the following co-pending provisional applications having at least one common inventor with this application: Ser. No. 60/893,616, filed Mar. 7, 2007, entitled “Method and System for Rules Based Tag Management in a Document Review System”; Ser. No. 60/893,613, filed Mar. 7, 2007, entitled “Method and, System for Universal File Types in a Document Review System”. The entire disclosures of the above applications are incorporated herein by reference.

The entire disclosure of commonly-assigned co-pending application Ser. No. not yet assigned, attorney docket no. 101915-200201/US, entitled “Method and System for Document Searching,” by inventor David A. Morales, filed the same day as this application, is incorporated herein by reference.

The entire disclosure of commonly-assigned co-pending application Ser. No. not yet assigned, attorney docket no. 101915-200301/US, entitled “Method and System for Searching and Generating To Do List,” by inventor David A. Morales, filed the same day as this application, is incorporated herein by reference.

The entire disclosure of commonly-assigned co-pending application Ser. No. not yet assigned, attorney docket no. 101915-200401/US, entitled “Method and System for Universal File Types in a Document Review System,” by inventor Willem van den Berge, filed the same day as this application, is incorporated herein by reference.

The entire disclosure of commonly-assigned co-pending application Ser. No. not yet assigned, attorney docket no. 101915-200501/US, entitled “Method and System for Hierarchical Document Management in a Document Review System,” by inventor David A. Morales, filed the same day as this application, is incorporated herein by reference.

### TECHNICAL FIELD

This invention relates generally to the field of document review systems. More particularly, the invention relates to a method and system for managing rules for applying tags to documents in a document review system.

### BACKGROUND

Document review systems are employed to search for specific words or phrases within a set of documents and identify documents % that meet specified criteria with a common identifier.

Document review systems are used for managing the document review in the discovery phase of litigation to determine, for example, which documents are relevant and which are irrelevant. A document that is relevant may be assigned a tag classifying it as relevant. A document that is irrelevant may be assigned a tag classifying it as irrelevant. One problem with document review systems is that documents can be tagged both relevant and irrelevant, for example, even though these two identifiers are inconsistent. What is needed is an ability to prevent inconsistent tag assignments.

### BRIEF SUMMARY

A system and method for reviewing documents are described. In one embodiment, the system includes an process configured to retrieve a document; an process configured to display the document; an process configured to create a plurality of tags, each of the plurality of tags being associated with a document characteristic; an process configured to define at least one rule, each rule being a restriction on the application of the plurality of tags to the plurality of documents; an process configured to associate at least one of the plurality of tags to the document; and an process configured to validate whether the plurality of tags assigned to the plurality of documents are consistent with each rule. In other embodiments, the process includes a machine-readable medium that provides instructions for a processor, which when executed by the processor cause the processor to perform a method of the present invention.

### BRIEF DESCRIPTION OF THE DRAWINGS

These and other features, aspects, and advantages of the present invention will become better understood with regard to the following description, appended claims, and accompanying drawings where:

FIG. 1 illustrates a block diagram of one embodiment of a system of the invention.

FIG. 2 illustrates a flow diagram of a method creating tags and tag rules according to one embodiment.

FIG. 3 shows a representation of a screen image in one embodiment of an tag creation process.

FIG. 4 shows a representation of a screen image in one embodiment of a tag rule creation process.

FIG. 5 shows a representation of a screen image in one embodiment of a tag rule creation process.

FIG. 6 is one embodiment of a method applying tags to documents.

FIG. 7 shows a representation of a screen image in one embodiment of a document tagging process.

FIG. 8 shows a representation of a screen image of the tag validation process according to one embodiment.

FIG. 9 shows a system having a machine-readable medium to store a set of instructions to perform a process according to one embodiment.

### DETAILED DESCRIPTION

At least some embodiments of the disclosure relate to a method and apparatus for performing document review.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but are not necessarily, references to the same embodiment; and such references mean at least one.

Reference in this specification to “one embodiment” or “an embodiment” means that a particular feature, structure, or characteristic described in connection with the embodiment is included in at least one embodiment of the disclosure. The appearances % of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

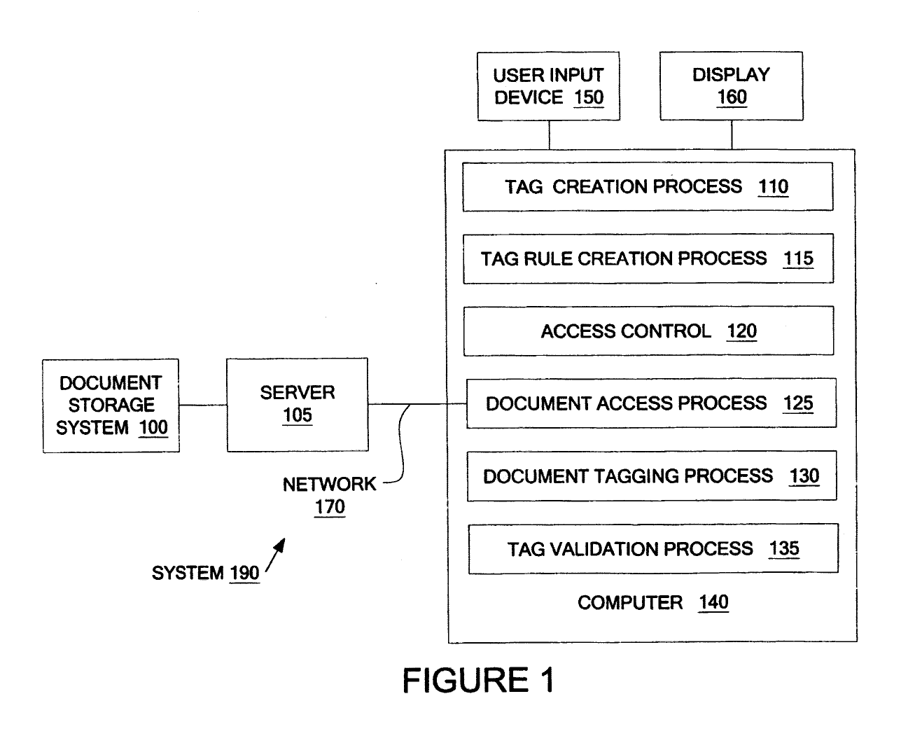

FIG. 1 illustrates one embodiment of a system of the present invention. A system 190 includes a computer 140 coupled to a user input device 150 and a display 160. The computer 140 is coupled through a network 170 to communicate with a server 105. The server 105 is coupled to access documents stored in a document storage system 100. In one embodiment, the system 190 is used for document review during the discovery phase of litigation. In other embodiments, the system 190 is used in other document review applications.

In one embodiment, the computer 140 receives a request for a document through the user input device 150 and requests the document through the server 105 to receive the document from the document storage system 100. The computer 140 displays the document on the display 160.

The user input device 150 may be a keyboard, a mouse, or some other device used to receive input from a user. In some embodiments, the user input device 150 includes more than one means to receive user input, such as: a keyboard and a mouse. The display may be a computer monitor or any other device used to present output of a computer.

The computer 140 includes a tag creation process 110, a tag rule creation process 115, an access control process 120, a document access process 125, a document tagging process 130, and a tag validation process 135.

In one embodiment, the tag creation process 110 is software running on the computer 140 that allows a user to create tags. Tags are identifiers used to indicate some predefined characteristic to be associated with particular documents by a document reviewer. Tags are used to differentiate documents that meet some specific criteria from the documents that do not. For example, in the discovery phase of litigation, a document reviewer might associate a “relevant” tag with a document to indicate that that document is relevant to an issue in the litigation. In some embodiments, the identifiers used to classify documents according to criteria are referred to by other names, such as markers, flags or folders.

The tag creation process 110 also includes the ability to associate tags with a folder structure corresponding to companies, projects and cases. In one embodiment, a tag associated with a company will be available for use on documents associated with all projects and cases within that company. A tag associated with a project will be available for use on documents associated with that particular project. A tag associated with a case will be available for use on documents associated with that particular case. In other embodiments, other methods of specifying, the availability of tags to document review activities may be used.

In one embodiment, the tag rule creation process 115 is software running on the computer 140 that allows a user to create tag rules and associate those tag rules with companies, projects and/or cases. Tag rules use logical statements based on the tags already assigned to the document. For example, a tag rule might specify that assignment of a tag indicating that a document is relevant (“relevant” tag) is not valid if the tag indicating that the document is irrelevant (“irrelevant” tag) has already been assigned to that document. Similarly, a tag rule might specify that assignment of the irrelevant tag is not valid if the relevant tag has already been assigned to the document. In this way, inconsistent application of the relevant and irrelevant tags is prevented. By defining a set of rules, prerequisites for the application of tags can be confirmed and contradiction in the application of tags can be avoided.

The tag rule creation process 115 also includes the ability to apply tag rules to a folder structure corresponding to companies, projects and cases. In one embodiment, a tag rule applied to a company folder will apply to documents in that folder and all projects and cases associated with the sub-folders within that company folder. A tag rule applied to a project folder will be applied to the project associated with that project folder. A tag rule applied to a case folder will be applied to the case associated with that case folder. In other embodiments, other methods of specifying the application and scope of tag rules to document review activities may be used.

In one embodiment, the access control process 120 is software running on the computer 140 that allows a user to control access to tags and tag rules. For example, some users may be allowed to view tags applied to each document, but not be allowed to modify or apply tags. Other users may be allowed to view, edit and apply tags. Some users may be allowed to edit tag rules and others might not. Particular users may be given different access permissions for different clients and different cases for each client. Other permission schemes may be used.

In one embodiment, the document access process 125 is performed on a network interface card configured to interface over a network 170 to the server 105.

In one embodiment, the document tagging process 130 is software running on the computer 140 that allows a user to associate tags with particular documents. A document is accessed using the document access process 125 and displayed on the display 160. The tag status of the tags that the user has permission to view are displayed. The user selects one or more tags to be associated with the displayed document.

In one embodiment, the tag validation process 135 is software running on the computer 140 that validates that the tags applied to a document satisfy the tag rules applicable to that document within the context of the current case or project. In some embodiments, the tag validation process 135 automatically validates the tag associations when a document is selected and When a tag association change is made. Tags may be applied or unapplied by clicking a checkbox, for example. Tag rule violations are reported on the display and updated as tag association changes are made.

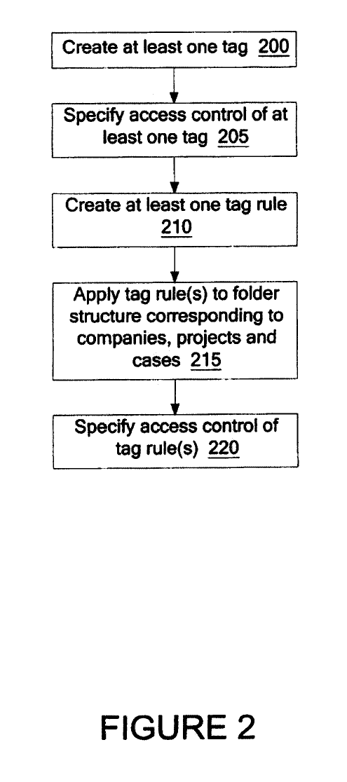

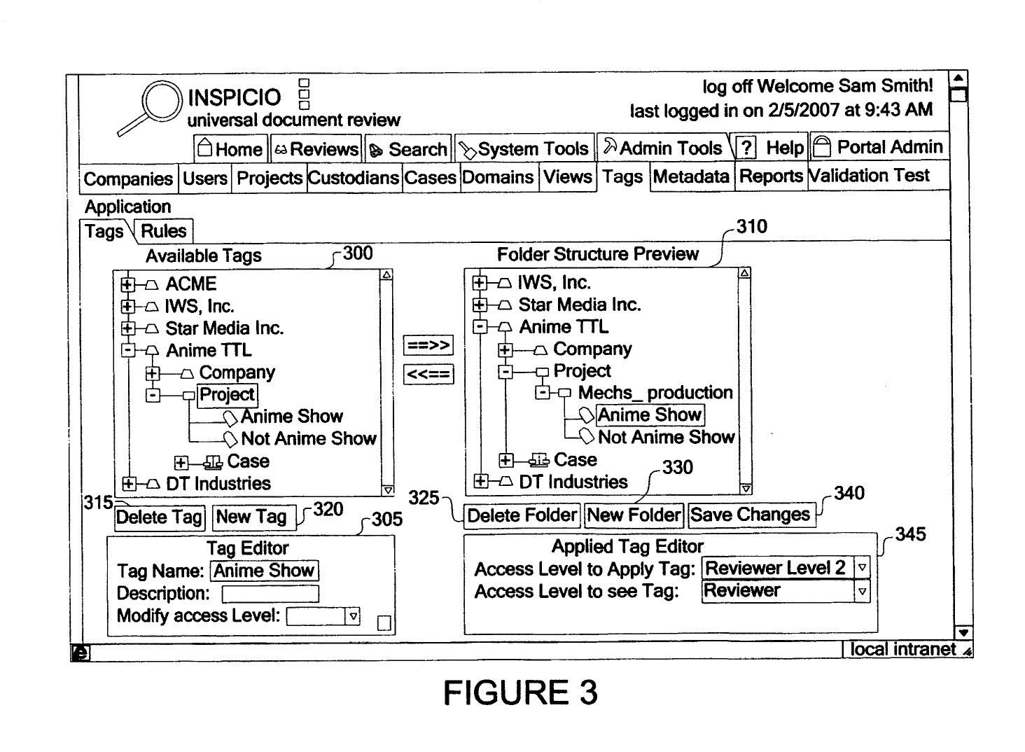

FIG. 2 is a flow diagram of one embodiment of a method of creating tags and tag rules. FIG. 2 is described in conjunction with FIGS. 3, 4, and 5, each representing screen images for various embodiments of the invention. In alternative embodiments, the processes and the data displayed can vary without departing from the scope of the invention.

In process 200, at least one tag is created. FIG. 3 shows a screen image of a display in one embodiment of a tag creation process 110. The Available Tags 300 window shows a folder structure containing tags. If a tag is selected, the Delete Tag button 315 is activated to allow the tag to be deleted. If a folder is selected, the New Tag button 320 is activated to allow a tag to be created within that folder. A Tag Editor 305 window allows the user to enter a tag name and description. The Folder Structure Preview window 310 displays the folder structure. The New Folder button 330 allows a new folder to be created. The Delete Folder button 325 deletes the selected folder.

The available tags can be applied to various folders and sub-folders within the folder structure to make the tag available to document review activities associated with particular companies, projects and cases. For example, a tag applied to a company is available to all cases and projects in that company folder. A tag applied to a case or project sub-folder in that company folder is made available to the particular case or project associated with that sub-folder. The Save Changes button 340 saves changes represented in the Folder Structure Preview window 340.

In process 205, access permissions to edit and apply the tag is specified for users. FIG. 3 shows a screen image of a display in one embodiment of an access control process 120. The Tag Editor window 305 allows the user to specify a modify access level for the selected tag. The modify access level is the minimum permission level that a user must have to modify that tag.

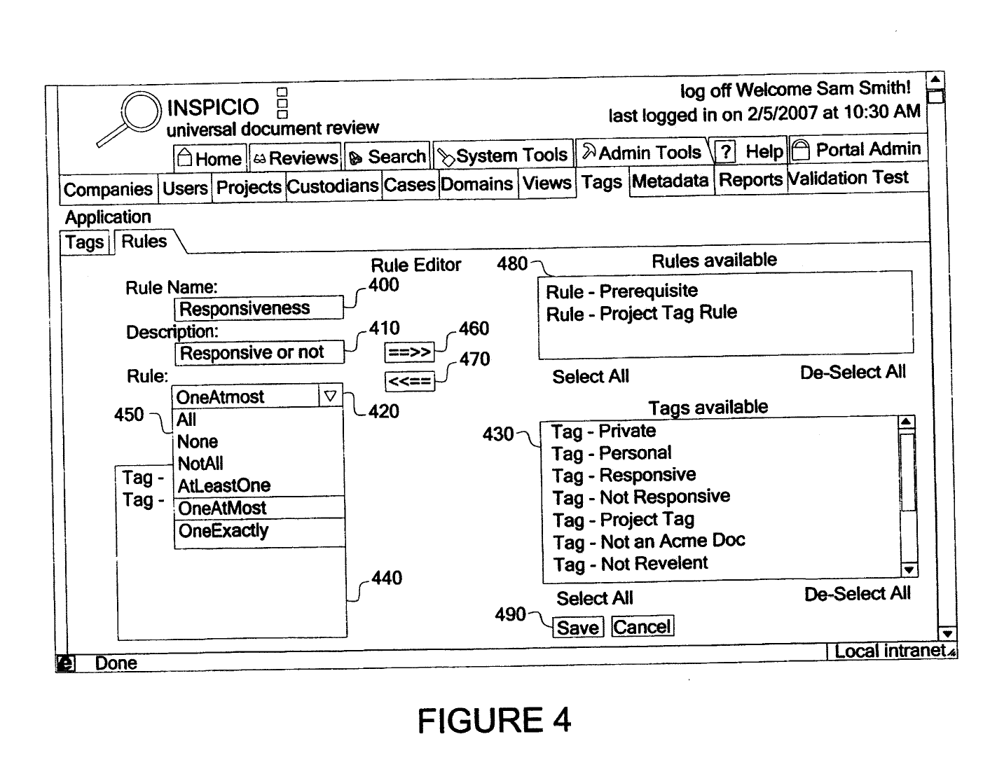

In process 210, the tag rules are created. FIG. 4 shows a screen image of a display in one embodiment of a tag rule creation process. A Rule Name Field 400 allows the user to specify the name of the tag rule. A Description Field 410 allows for the user to describe the tag rule.

The Rule Field 420 allows the user to specify one of several rule constructs. The “All” rule construct requires that all selected tags be applied to the document. The “None” rule construct requires that none of the selected tags are applied to the document. The “NotAll” rule construct requires that none or some of the selected tags can be applied but not all of the selected tags are applied to the document. The “AtLeastOne” rule construct requires that at least one of the selected tags is applied to the document. The “OneAtMost” rule construct requires that none or one of the selected tags are applied to the document. The “OneExactly” rule construct requires that exactly one of the selected tags is applied to the document.

One or more tags are selected from the Available Tags window 430 and the Left Arrow button 470 in the middle of the screen image. Is clicked. These selected tags then are listed in the Selected Tags window 440 (title obscured) under the Rule Selection Drop Down Field 450. Tags can be unselected by selecting one or more tags in the Selected Tags window 460 and clicking on the Right Arrow button 460 in the % middle of the screen.

When the Save button 490 is selected, the tag rule is saved and listed in the Available Rules window 480.

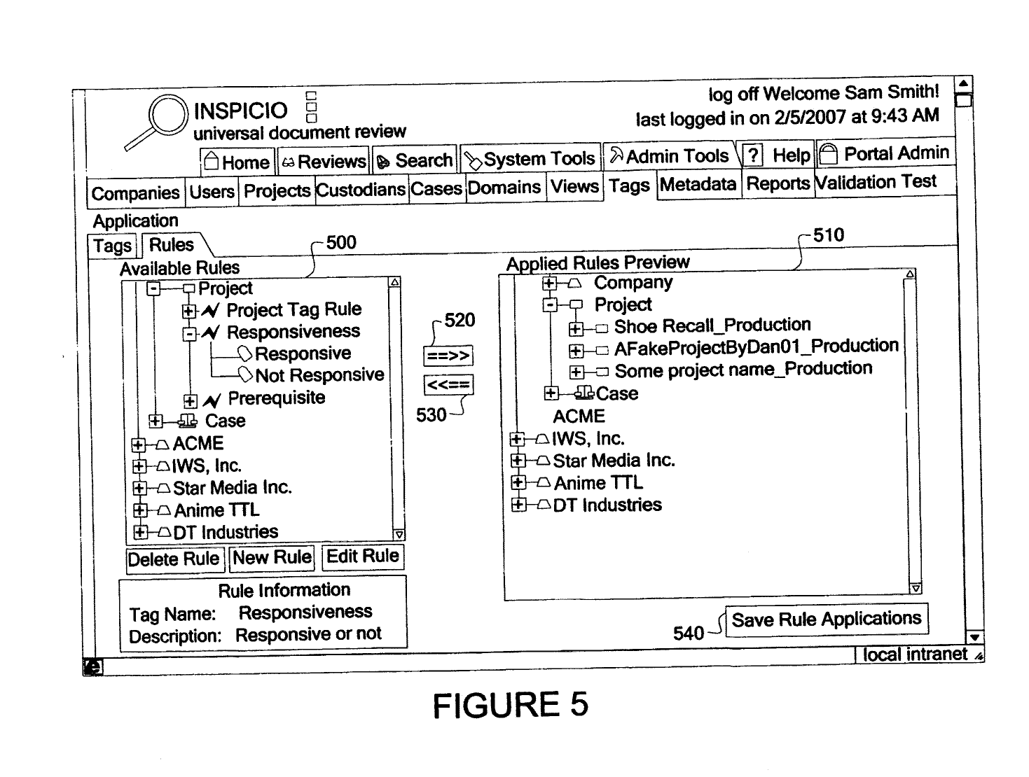

In process 215, the tag rules are applied to a folder structure having directories corresponding to companies, projects and cases. FIG. 5 shows a representation of a screen image in one embodiment of a tag rule creation process. In the available rules window, Available Tag Rules 500 are organized in a folder structure. When a tag rule is selected, information about the rule is displayed in the rule information window. A button to delete the selected rule and a button to edit the selected rule is available. When a rule is not selected, a button to create a new rule is available.

In the Applied Rules Preview window 519, the user can apply the tag rules with a scope that depends on the organizational element, such as company, project, case, that is associated with the selected folder. A tag rule is selected in the Available Tag Rules window 500 and an organizational element is selected in the Applied Rules Preview window 510. The Right Arrow button 520 in the middle of the screen is used to apply the selected tag rule to the selected directory in the applied rules preview window. The Left Arrow button 530 removes a selected tag rule from the element in the Applied Rules Preview window 510.

The tag rules are listed under folders corresponding to particular companies (e.g., clients for a document review task) and under company folders in folders corresponding to particular cases (e.g., a particular legal dispute) or projects. Rules stored under company folders are applicable to all company cases. Rules stored under case folders are applicable to that particular case. Rules stored under project folders are applicable to that particular project. The Applied Rules Preview window 510 shows a preview of the applied tag rules based on the tag rules applied, but these changes do not become effective until a Save Rule Applications button 540 is clicked.

In process 220, access permissions to view particular tags and apply particular tags to documents is specified for users. FIG. 3 shows a screen image of a display in one embodiment of an access control process 120.

The Applied Tag Editor window 345 allows the user to specify the minimum access level required to see the tag and the minimum access level to apply the tag in document review activities. This access control setting is specific to the tag as applied in the applied location in the folder structure. The same tag can be applied in different folder structures, thereby creating multiple applied tags, each having independent access control permissions.

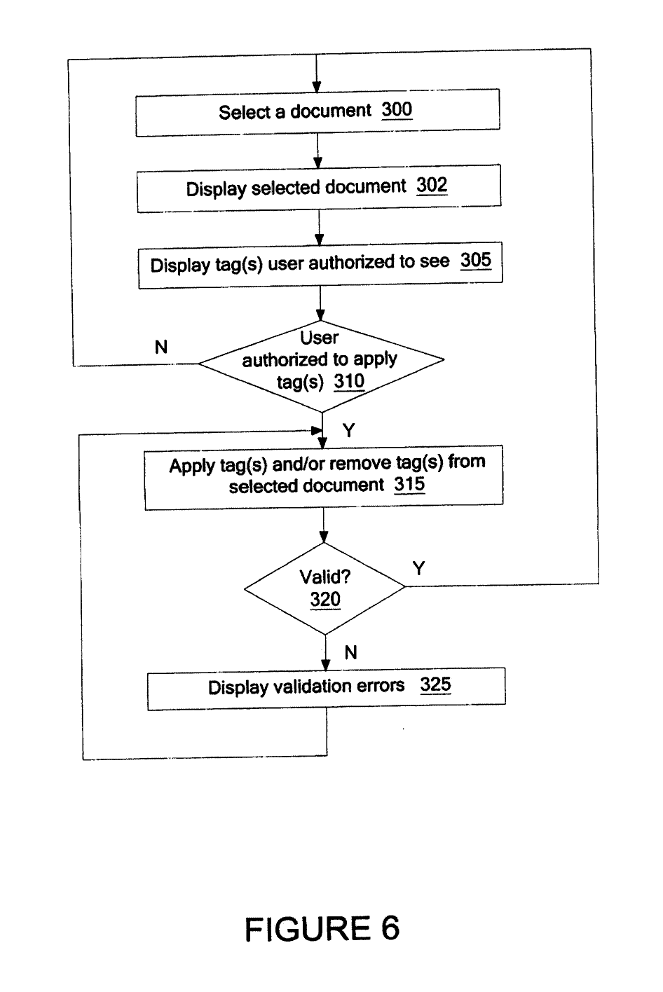

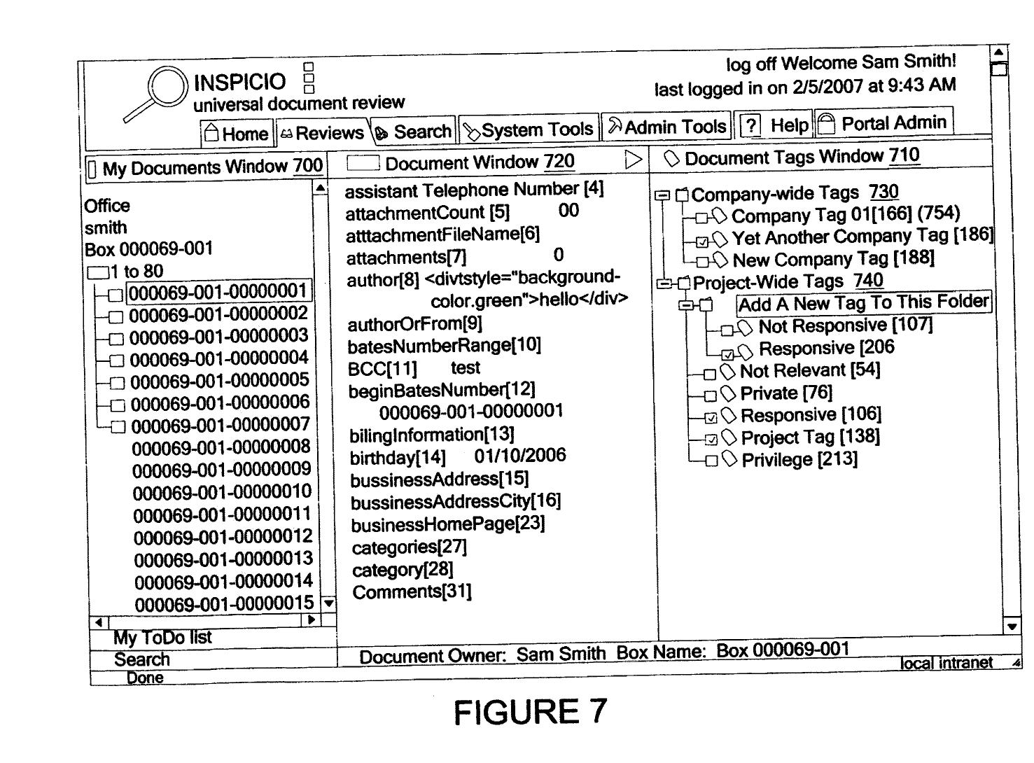

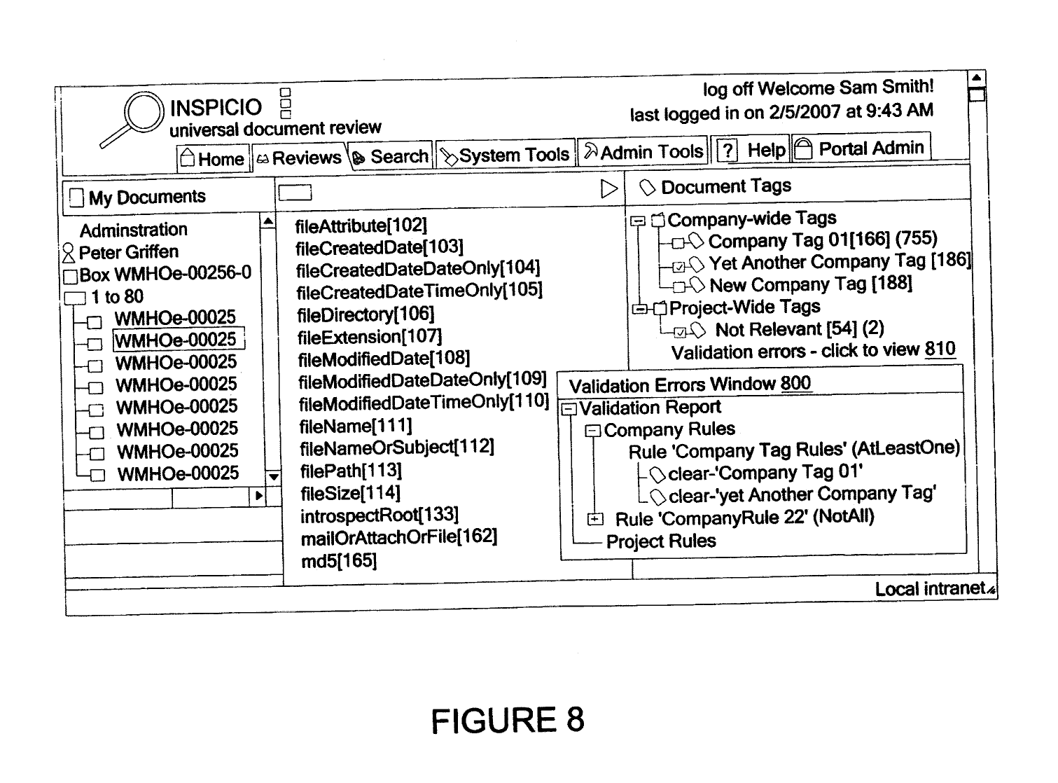

FIG. 6 is one embodiment of a method applying tags to documents. FIG. 6 is described in conjunction with FIGS. 7 and 8 representing screen images in one embodiment of the invention.

In process 300, at least one document is selected. FIG. 7 shows a representation of a screen image of a display in one embodiment of a document tagging process 130. The My Documents window 700 includes a set of documents.

In process 302, the selected document is displayed. In one embodiment, the selected document is retrieved through a network by the document access process 125. FIG. 7 shows the document is displayed in the Document window 720 between the My Documents window 700 and a Document Tags window 710.

In process 305, tags are displayed according to the user access controls. In one embodiment, user accounts are created, including a user name, password and access control permission level. The user logs into the system using the user name and password.

If the user is authorized to see a tag, it is displayed in the Document Tags window 710. If a user is not authorized to see a tag, it is not displayed in the Document Tags window 710. There is folder within the Document Tags window 710 for company-wide tags 730. Company wide tags are applicable to all projects and cases within the company and specifically applicable to the selected document. There is a folder in the Document Tags window 710 for project-wide tags 740. These tags are applicable to all documents associated with the current project and applicable to the selected document. In some embodiments, there is a folder in the Document Tags window 710 for case-specific tags. These tags are applicable to all documents associated with the current case and applicable to the selected document.

A check box is adjacent to each tag in the Document Tags window 710. If the check box has a check mark, the tag is applied to the selected document. If the check box does not have a check mark, the tag is not applied to the selected document. By viewing this display the user can determine which tags are applied to the document, of the tags that user is authorized to see. However, the user does not necessarily have authorization to apply or remove tags from the document.

In process 310, it is determined whether the user is authorized to apply and remove tags based on the access control process 120. If the user is authorized to apply and remove tags, process 315 is performed. Otherwise, process 300 is performed.

In process 315, tags are applied and/or removed from the selected document. In one embodiment, tags are applied to the selected document by clicking a button on the mouse while pointing the cursor on the check box associated with the selected tag to insert a check mark in the check box. Tags are removed from the selected document by clicking a button on the mouse while pointing the cursor on the check box associated with the selected tag to remove a check mark in the check box.

In process 320, a validity check is performed by testing one or more tag rules applicable to this company, project and/or case. The scope of a tag rule is specified by applying it to a particular level in the folder structure as described herein. The validity check tests each tag rule applicable to this document. If there are not validation errors, process 300 is performed. If there are validation errors, process 325 is performed.

The validity check is triggered by a user action, such as a click of one of the checkboxes to add or remove a tag association with the document.

In process 325, the validation report is displayed. FIG. 8 shows a screen image of a display in one embodiment of a document tag validation apparatus. FIG. 8 has a Validation Errors window 800 in the foreground that overlays a background image similar to FIG. 7. If validation errors are identified, a text line 810 indicating that there are validation errors is listed at the end of the tag listing in the Document Tags window 810. By clicking the text line 810, the Validation Errors window 800 pops into the foreground. In one embodiment, tag rules that are not satisfied are displayed in red and rules that are satisfied are displayed in green.

Process 315 is then performed. The user can apply and remove tags according to the method described herein to address the tag validation errors. In some cases, the user may determine that some tag rules should be modified and modify the tag rules using the tag rule creation apparatus according to the method described herein.

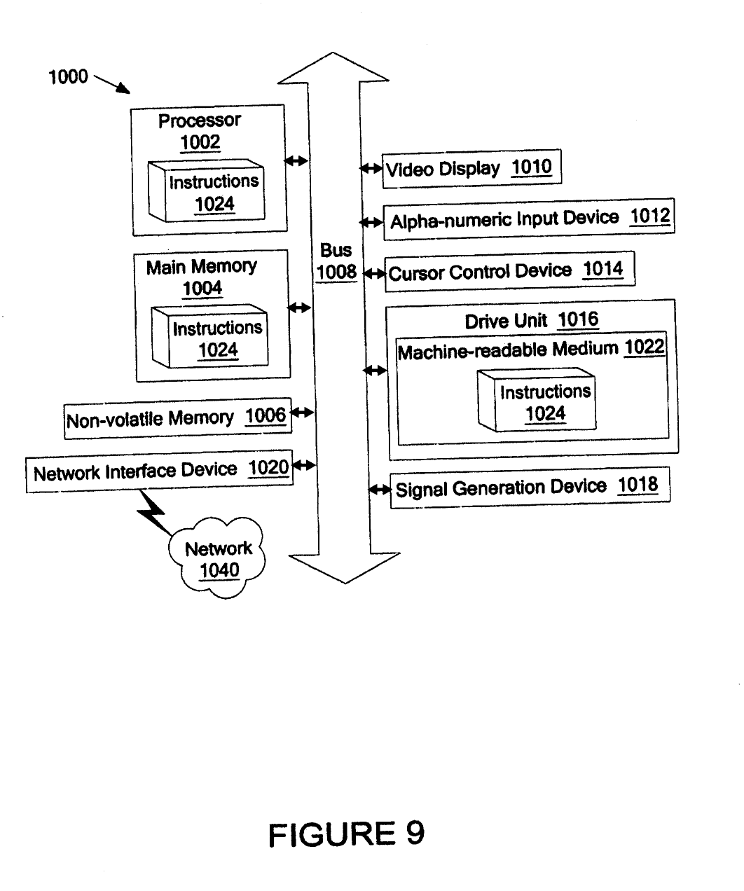

FIG. 9 shows a diagrammatic representation of a machine in the exemplary form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 1000 includes a processor 1002 (e.g., a central processing unit (CPU) a graphics processing unit (GPU) or both), a main memory 1004 and a nonvolatile memory 1006, which communicate with each other via a bus 1008. In some embodiments, the computer system 1000 may be a laptop computer, personal digital assistant (PDA) or mobile phone, for example. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020. The disk drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media. The software 1024 may further be transmitted or received over a network 1040 via the network interface device 1020.

While the machine-readable medium 1022 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

In general, the routines or processes executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system comprising:
a process to create a plurality of tags, each of the plurality of tags being associated with a document characteristic;
a process to define at least one rule, each rule being a restriction on the application of the plurality of tags to a plurality of documents;
a process to associate at least one of the plurality of tags to one or more documents of the plurality of documents; and
a process to validate whether the plurality of tags assigned to the plurality of documents are consistent with each rule.

2. The system of claim 1 in which process to validate whether the plurality of tags assigned to the plurality of documents are consistent with each rule is further configured to perform the validation in real time.

3. The system of claim 1 further comprising a apparatus for managing access control for a plurality of users, wherein the process for associating at least one of the plurality of tags to the document comprises a process for preventing at least one of the plurality of users from modifying the tag associations based on the access control configuration.

4. The system of claim 1 further comprising a process for managing access control for a plurality of users, wherein the process for associating at least one of the plurality of tags to a plurality of documents comprises a process for preventing at least one of the plurality of users from seeing at least one of the tag associations based on the access control configuration.

5. The system of claim 1 wherein the process configured to create a plurality of tags is further configured to associate each tag with at least one folder in a folder structure, the tag being applied to projects associated with the folder and all subdirectories of that folder in the folder structure.

6. The system of claim 1 wherein the apparatus configured to create a plurality of tag rules is further configured to associate each tag with at least one folder in a folder structure, the tag rule being applied to projects associated with the folder and all subdirectories of that folder in the folder structure.

7. A method for document review comprising:
defining a set of one or more tags, with each tag being associated with a document classification;
defining one or more rules associated with each tag, each rule being a restriction on the application of the tag to the document;
associating at least one of the tags to one or more documents; and
validating whether the tag assigned to the one or more documents is consistent with each rule.

8. The method of claim 7 further comprising:
specifying access control for a plurality of users; and
preventing at least one of the plurality of users from modifying at least one tag associations based on the access control configuration.

9. The method of claim 7 further comprising:
specifying access control for a plurality of users; and
preventing at least one of the plurality of users from seeing at least one tag associations based on the access control configuration,

10. The method of claim 7 wherein process creating a plurality of tags further comprises associating a tag with at least one folder in a folder structure, the tag being applied to projects associated with the folder and all subdirectories of that folder in the folder structure.

11. The method of claim 7 wherein process creating a plurality of tag rules further comprises associating a tag rule with at least one folder in a folder structure, the tag rule being applied to projects associated with the folder and all subdirectories of that folder in the folder structure.

12. A machine-readable medium that provides instructions for a processor, which when executed by the processor cause the processor to perform a method comprising:
defining a plurality of tags, each of the plurality of tags being associated with a document classification;
defining at least one rule, each rule being a restriction on the application of the plurality of tags to a plurality of documents;
associating at least one of the plurality of tags to one or more documents of the plurality of documents; and
validating whether the plurality of tags assigned to the plurality of documents are consistent with each rule.

13. The machine-readable medium of claim 12, wherein the validating the one or more tags is performed in real time.

14. The machine-readable medium of claim 12 in which at least one rule comprises a restriction that a first tag can only be applied to a document if a predetermined first set of tags is applied.

15. The machine-readable medium of claim 12 in which at least one rule comprises a restriction that a first tag can only be applied to a document if a none of a predetermined first set of tags is applied.

16. The machine-readable medium of claim 12 in which at least one rule comprises a restriction that a second tag can only be applied to a document if not all of a predetermined first set of tags is applied.

17. The machine-readable medium of claim 12 in which at least one rule comprises a restriction that a second tag can only be applied to a document if at least one of a predetermined first set of tags is applied.

18. The machine-readable medium of claim 12 in which at least one rule comprises a restriction that a second tag can only be applied to a document if at most one of a predetermined first set of tags is applied.

19. The machine-readable medium of claim 12 in which at least one rule comprises a restriction that a second tag can only be applied to a document if exactly one of a predetermined first set of tags is applied.

20. The machine-readable medium of claim 12 further comprising:
specifying access control for a plurality of users; and
preventing at least one of the plurality of users from modifying at least one tag associations based on the access control configuration.
